(19) United States
(12) Patent Application Publication
(10) Pub. No.: US 2002/0038388 A1
(43) Pub. Date: Mar. 28, 2002

(54) System and method for capture and playback of user interaction with web browser content

(76) Inventor: Zvi Itzhak Netter, Petach-Tikva (IL)

Correspondence Address: LeBoeuf, Lamb, Greene & MacRae, LLP, Suite 2000, 633 Seventeenth Street, Denver, CO, 80202, US

(21) Appl. No.: 09/952,946

(22) Filed: Sep. 13, 2001

Related U.S. Application Data
(60) Provisional application No. 60/230,916, filed on Sep. 13, 2000.

(51) Int. Cl. G06F 9/46

(52) U.S. Cl. 709/318

(57) ABSTRACT

A system and method for capturing and managing any browser actions or occurrences, oftentimes generated by a user but not always, is disclosed. It allows easy user analysis, manipulation and/or distribution of captured data in an application, as desired. Advantageously, the present invention also facilitates collaborative use. Further, when implemented on a web site, it extends the data capture/analysis/manipulation features capability to the site such that one may audit, in real time, any web page activity, whether or not performed by a user, or any collaboration activity as well.

### RELATED APPLICATION

This application is related and claims priority to U.S. Provision Application Ser. No. 60/230,916, filed Sep. 13, 2000, and entitled, “A method for creating and sharing applications in multi-user, multi-server environments”, which is incorporated herein by reference.

### FIELD OF INVENTION

The present invention generally relates to the fields of data analysis and development platform systems. More particularly, the present invention relates to a method and system, usable in web-based platforms, that captures in part as analyzable data for subsequent manipulation or distribution, user interactions involving web browser content information. What is more, the present invention allows for the capture and playback of all browser interactions, including interactions not directly activated by a user event.

### BACKGROUND OF INVENTION

With the increasing use of computers for communications and business services, there is a growing need for technology solutions that manages data content to users efficiently, reliably and inexpensively. The introduction of the world wide web (“web”) catapulted use of the internet as a popular repository of vast amounts of data.

Generally, the internet is a network of connected computers, including local and wide area networks, that use the Transmission Control Protocol/Internet Protocol (TCP/IP) suite of protocols. These protocols are common protocols that allow many computers, even those with incompatible technologies, to communicate with each other and integrate diverse components.

The web is a graphical user interface to the internet that allows users to access, view or search for information over the internet. Web pages generally contain text and graphical data that are typically stored on computers called web servers.

The layout and content of a Web page is generally described according to Hyper Text Transport Protocol (HTTP) instructions. And data may generally be described in Hyper Text Markup Language (HTML) instructions, such that one or more web pages essentially represent computer files in HTML format. Using the language of HTML, web servers create and connect web pages that are displayed to a user.

In addition to text and graphical data specified in HTML format, a web page contains highlighted words or phrases in the form of links or embedded information (i.e. URLs) identifying a specific address of other web pages on the internet. By pointing and clicking on a link, a user accesses other web pages, which in turn contains other data and/or additional links.

The software program that allows users to access and view and navigate web pages via the internet is called a browser or web browser. A browser is a graphical interface tool that essentially runs the HTTP internet protocols, and displays text, sound, image, video and other data on a user's screen. Through a web browser, users seeking information on the internet generally switch between servers or databases by clicking on links.

With the recent exponential growth of multimedia content on the internet, there is increasing concern over whether the internet can deliver data, particularly audio and video data and/or audio/video data streaming, instantaneously. Various extensions to HTML have been made to enable browsers to be capable of handling data other than simply text and images. One example is the network program “applets” written in Java or other similar language that is used to extend the functionality of the browser environment or network.

The following patent application represents the state of the art, and is hereby incorporated by reference:

U.S. Patent Application to Ohkado et al. discloses a method for acquiring content information, and software product, collaborative system and collaboration server for acquiring content information.

While the foregoing concern for delivering and manipulating multimedia data instantaneously is well understood and effective techniques for addressing it have been developed, there are significant drawbacks. One such drawback is the bandwidth requirements. Bandwidth generally refers to the amount of data that can be transmitted over a network segment at any given time.

Unlike text and still image data, which require low storage and bandwidth requirements, audio and video data typically require much higher storage and bandwidth. For example, when recording user activity using a desktop program or when recording sessions using an application sharing software, the output video is usually oversized therefore playback of these video files at too slow speeds produce images that plays back slower than originally recorded. Or, if the playback speed is uneven, the video looks jerky. In effect, providing high speed transmission of multimedia data over a computer network, such as the internet, is very difficult.

Another drawback to managing multimedia data over a public network is user control and flexibility. Existing techniques that have been developed for use with multimedia data do not allow for a user to separately control the information, including selected portions thereof, as desired by the user.

### SUMMARY OF INVENTION

The present invention satisfies, to a great extent, the foregoing and other needs not currently met by existing development platform systems and information processing systems and methods. In accordance with the present invention, a system and method for capturing and managing data within a closed application, including one or more users' interaction with the data, is disclosed. The closed application may reside on a web browser in a web page, and may comprise any software application, such as a JAVA™ applet-written software, a registration form, an URL link, or the like.

The system of the present invention comprises client modules and optional server modules for facilitating capture of web interaction for subsequent user manipulation as desired, including local or remote collaborative playback. In local mode, the user is able to capture and playback all web interaction using the client modules only. In collaborative mode, the user is able to share his or her interactions with one or more users on the system using the client modules and the server modules.

The client modules comprise capture and playback applets responsible for performing all of the functionalities necessary to effect capturing and playing back of every change event.

The client modules also comprise a gateway applet responsible for managing the data captured by the capture and playback applets in each change event, both when in the local or collaborative mode. The gateway applet acts as an interface unit between the capture and playback applets, and the server components of the server modules. It also supports sending and receiving of messages to remote users, remote storage of the captured data, as well as local storage of the captured data.

In a preferred embodiment, the functions of the capture and playback applets are divisible into four categories. The first category takes the form of a browse or navigate applet. This applet category is responsible for capture and/or playback or broadcast of all change events, whether directly activated by a user or not. A navigation event is best described as any action or occurrence, generated by a user. For example, key presses or button clicks by a user during browsing of a web page that cause new web pages to load, are navigation events that a browse applet is capable of capturing and/or broadcasting as desired.

The second category is called a change applet, which is responsible for capturing application object events while interacting in a browser. Application object events may comprise Java™ or ActiveX™ objects initiated by an input device, such as a keyboard or a mouse. Whenever a user operates an application object, the change applet will capture any changes the user makes to the application object for later processing.

The third category of the capture and playback applets takes the form of a form applet. A form applet is responsible for capture and playback of any activity related to Hyper Text Markup Language (HTML) forms. The activity may be moving between fields, changing data values and the like.

The fourth category is the function applet, which is responsible for capture and playback of any script function being called on a web page. In some cases, a trigger for an event is not a direct user action. It may be a specific script function. In the latter instances, the function applet may be used to capture the function call.

Alternatively and optionally, the functions of the capture and playback applets may be grouped into more than four categories. These functions may be any number of desirable features. For example, a fifth category of the capture and playback applets may be directed to a draw applet, which, in addition to specific script functions, facilitates drawing on HTML layers, both locally and cooperatively.

In a preferred embodiment, the functions of the gateway applets are also divided into four sub-modules. The first sub-module relates to the collaboration services of a messaging server. These services are responsible for the send/receive and save/load functions of the captured data between one or more users who collaborate in real time over a communications network, such as the Internet.

A second sub-module of the gateway applets takes the form of local events storage where local storage of captured data is stored in a local memory buffer for subsequent playback or broadcast, as desired. The recorded data may also be saved to physical storage (i.e. files) locally for later playback.

A third sub-module takes the form of a registry service, which manages the registry database of the captured applets loaded on a browser. The fourth sub-module is a remote events storage, used for remote storage of the captured data that is saved on a remote data store over a communications network.

Having discussed the client modules, we now turn our attention to the server modules. The server modules of the present invention preferably comprise a messaging server and a database server. The messaging server comprises a messaging server engine, such as an Internet Relay Chat (IRC) server, coupled to an extension module. The extension module extends the standard messaging server engine functionality to be able to handle the messaging server requirements.

The messaging server and extension module collectively effects collaboration management. The database server is responsible for data recording and conferences management. Alternatively, the messaging and database server may comprise one server, rather than two separate servers.

In one aspect of the invention, a system for recording as real data one or more change events in a browser, wherein the real data includes function calls that are directly activated by a user event and function calls not directly activated by a user event, is disclosed.

The system comprising: (a) one or more gateway components each substantially configured for at least one of registering, storing and managing recorded data representing one or more change events, each gateway component managing recording of the data in such a way that the data recorded is capable of data analysis to a desired degree of specificity; and (b) one or more capture and playback applets, each in operative communication with the one or more gateway components, substantially configured for performing all functionalities necessary to effect recording and replay of one or more change events.

In this system, each gateway component acts as an interface between the one or more capture and playback applets and one or more optional server components. The one or more capture and playback applets is integral with the one or more gateway components. Each gateway component is modifiable to perform additional features as desired.

Each gateway component further comprises: a collaboration services module configured to allow collaboration between one or more users in real time; a local storage module configured to allow local storage of at least one of data and a message; a registration module configured to manage registration of capture and playback applets loaded on a browser; and a remote storage module configured to allow remote storage of at least one of data and a message.

Recording of data occurs substantially instantaneously without requiring an instruction command from a user.

Additionally, each capture and playback applet further comprises: a browse applet configured to detect one or more change events made to a web page; a change applet configured to enable recording and subsequent manipulation of an existing applet and any change event associated with said existing applet; a form applet configured to communicate with one or more form objects in a HTML page; and a function applet configured to allow remote execution of script functions.

Each capture and playback applet interfaces with each gateway component.

The system further comprises: a messaging server configured to manage multiple channels of users and to exchange messages between them; an extension module, operatively connected to a messaging server, configured to supervise said messaging server messages; and a storage device for storing at least one of data and a message, in local or collaborative mode.

The extension module administers: storing and retrieving functions of said messaging server; substantially all functions for conference management; and configuration of system functions to allow modification to user log-in access.

The extension module also manages an electronic directory service of users, and performs dynamic updating of user status information to a database.

In another aspect of the invention, a protocol for applet communication that captures one or more user interactions involving web browser content information, is provided. The protocol comprises: (a) code instructions for detecting a change event in a browser; (b) code instructions for detecting a change event in an application object; (c) code instructions for detecting a change event in one or more form objects in a HTML page; (d) code instructions for detecting a change event in one or more script functions in a web page; (e) code instructions for supporting send/receive and save/load functions of captured data between two or more users who collaborate in real time; (f) code instructions for local storage of captured data; (g) code instructions for remote storage of captured data; and (h) code instructions for management of a registry database of captured applets loaded on a browser.

In yet another aspect of the invention, a software useful for managing one or more interactions involving web browser content information, is provided. The software comprises program procedures for capturing a change event in: a browser; an application object; form objects in a HTML page; and one or more script functions in a web page.

The software further comprises program procedures for: supporting collaboration in real time between two or more users; for locally storing the captured change event; for remotely storing the captured change event; and for managing registry of captured applets loaded in a browser. The change event is represented by data capable of analysis to a desired degree of specificity.

It is important to recognize that there are a number of key differences between the present invention and existing application capturing technologies, which captures user activity on a computer, and application sharing technologies, which transmits user interactions on one computer over a network to another remotely located computer.

The first major difference is limited updating control. In the application capturing environment, only the user, primarily the session or host manager, can initiate an updating activity. In the application sharing environment, a maximum of two users can collaborate. On the other hand, in the system of the present invention, any number of users or clients can initiate an updating activity. The present invention allows for multi-user updating.

A second major difference is limited bandwidth. In the application capturing environment, bandwidth is not an issue because there is no collaborative support. In the application sharing environment, screen captures are constantly sampled, compressed and transmitted. Despite being compressed, screen captures still requires wide bandwidth capabilities, unlike as with the present invention, which does not employ screen capturing and consequently requires low bandwidth.

A third major difference, flowing from the limited bandwidth problem, is undesirable graphical user interface (GUI) updating. In both the application capturing and application sharing environments, particularly at the instant when screen captures are played and transmitted, respectively, the GUI “jumps” during updating, especially when the application is being updated at a rapid speed. On the other hand, in the system of the present invention, updates occurs constantly and smoothly, thereby eliminating GUI jumping.

A fourth major difference is installation. In the application capturing environment, software installation on a computer is required. In addition to installing software on a computer, in the application sharing environment, an application sharing enabling software must be installed on the other computer. On the contrary, in the present invention, no software installation on any client computer is required.

A fifth major difference is the architecture. In the application capturing environment, only stand-alone architecture is employed. In the application sharing environment, computers are directly connected to facilitate the collaborative process. However, the architecture of present invention is flexible; it accommodates both stand-alone, client-to-client (directly connected) and many-to-many (client-server) configurations.

One advantage of software components of the present invention being Java™ applets is that the system is operationally platform independent. In other words, the system of the present invention can work in any web browser that has the Java™ Virtual Machine (JVM) already installed, because substantially all leading browsers employ JVM.

A major advantage of the present invention is the capturing of real data, rather than screen captures. This is a significant advantage over existing capture applications. In the present invention, real data is transmitted between the applets, and is stored locally and/or remotely via the gateway applet. This configuration not only allows for the storing and re-broadcasting of all sessions information, but also allows for the creation of detailed data analysis.

A further advantage of the present invention is achievement of asynchronous collaboration. One of the uses of this functionality is saving captured sessions for later playback. For instance, a pre-recorded session can be transmitted using electronic mail. Once a user receives a recorded session, the user can log in to the site and load the pre-recorded session for individual or shared playback.

Yet a further advantage of the present invention is the absence of delays and, hence, increased speed in the transfer and broadcast process of data. This is accomplished by transferring end data points representing a final change a user makes, rather than transferring every intermediate data point up to and including the final change made. In this fashion, each user's action generates a transaction where small amounts of data (i.e. end data points only) are transmitted very quickly. Moreover, a smooth movement is simulated in those cases where only end data points are received.

Yet a further advantage of the present invention is its easy and rapid implementation. Implementation of web site interactive capture and playback functionality in accordance with the principles of the present invention, does not require complex or additional hardware and/or software. Such functionalities are accomplished by the use of automated tools that can add code and applets to a site.

Yet a further advantage of the present invention is the low bandwidth requirement for adequate use. For instance, transmission and broadcast of data in the present invention is effective even for users connected to a server via a telephone dial-up modem at a speed of 9.6 Kbps.

Yet a further advantage of the present invention is substantially unlimited capacity. An unlimited number of users may activate the same applet or application, and work on it collaboratively without substantial data transfer delays.

There has thus been outlined, rather broadly, the important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the present invention is not limited in its application to the details of construction and to the arrangements of the specific components set forth in the following description or illustrated in the drawings only. The present invention is capable of other embodiments and of being practiced and implemented in various ways. Also, it is to be understood that the phraseology and terminology employed herein are for the purpose of description and should not be regarded as limiting.

As such, those skilled in the art will appreciate that the conception, upon which this disclosure is based, may be readily used as a basis for designing and/or arrangement of other structures, methods and systems for carrying out the several purposes of the present invention. It is important, therefore, that the claims be regarded as including such equivalent constructions insofar as they do not depart from the spirit and scope of the present invention.

Further, the purpose of the foregoing Abstract is to enable the U.S. Patent & Trademark Office and the public generally, and especially software developers, engineers and practitioners in the art, who are not familiar with patent or legal terms of phraseology, to determine quickly from a cursory inspection, the nature and essence of the technical disclosure of the application. The Abstract is neither intended to wholly define the present invention of the application, which is measured by the claims, nor is it intended to be limiting as to the scope of the invention in any way.

The above features, advantages and objects of the present invention, together with other apparent features and advantages of the invention, along with the various features of novelty that characterize the invention, are pointed out with particularity in the claims annexed to and forming a part of this disclosure. For a more detailed description of the present invention, its operating advantages and the specific features and objects attained by its uses, reference should be had to the accompanying drawings and descriptive matter, which illustrates preferred embodiments of the present invention.

### BRIEF DESCRIPTION OF PREFERRED EMBODIMENTS

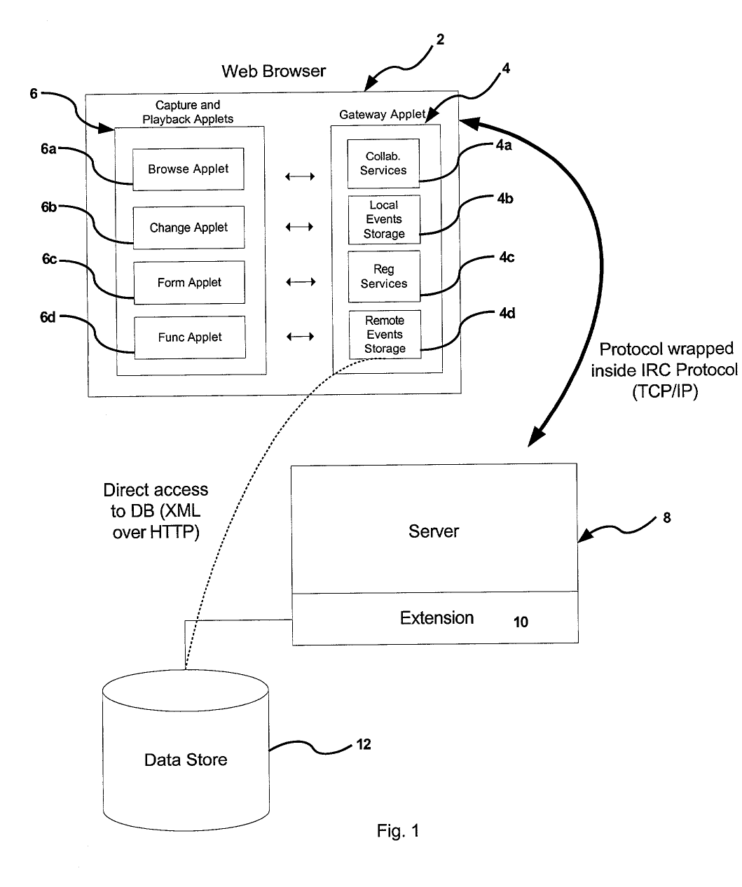

FIG. 1 is a block diagram showing the client and server components supporting a preferred embodiment of the present invention.

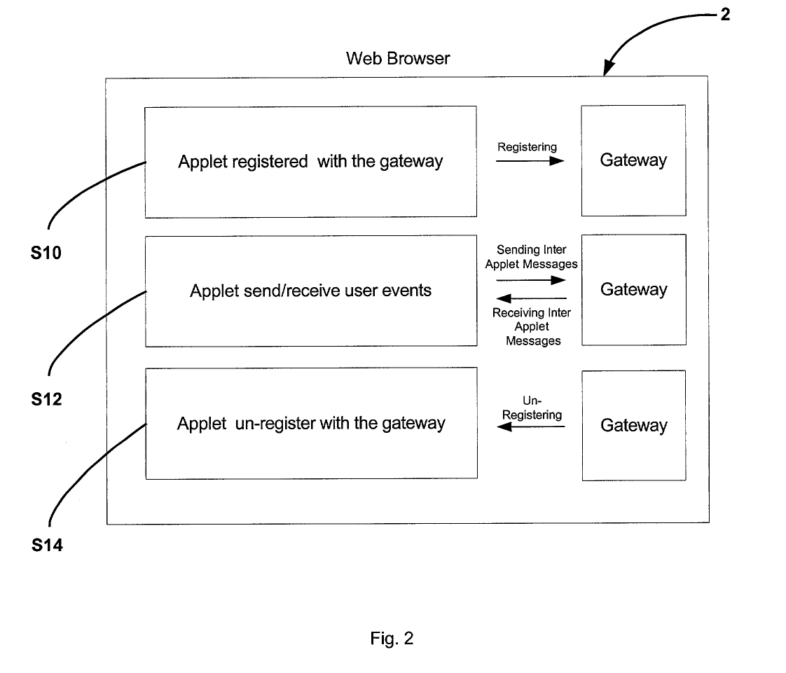

FIG. 2 is a block diagram showing the decision logic when a web page implementing the present invention is loaded on a browser.

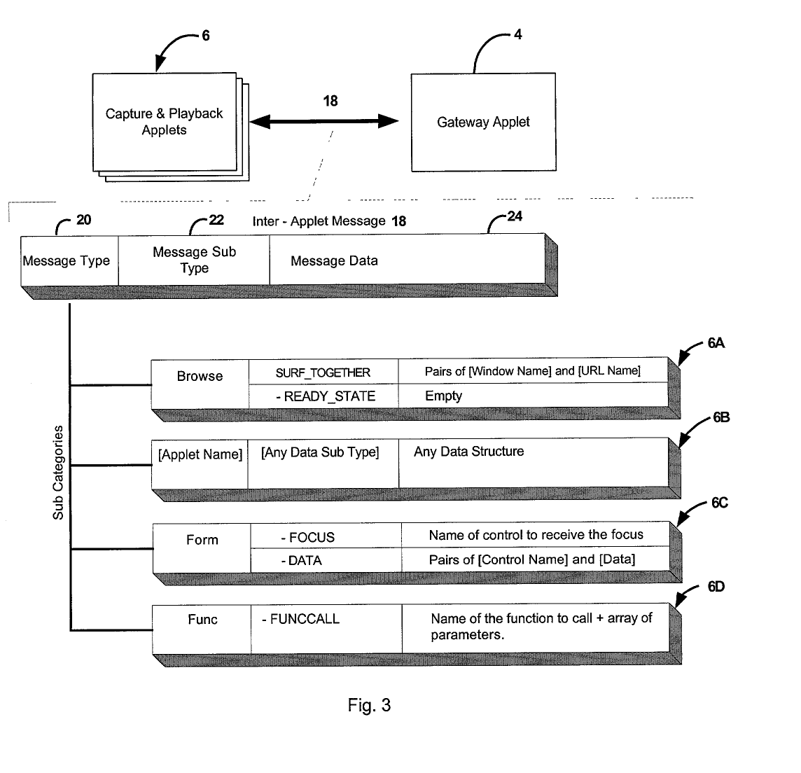

FIG. 3 is a block diagram showing the protocol message format of the inter-applet messages in accordance with the present invention.

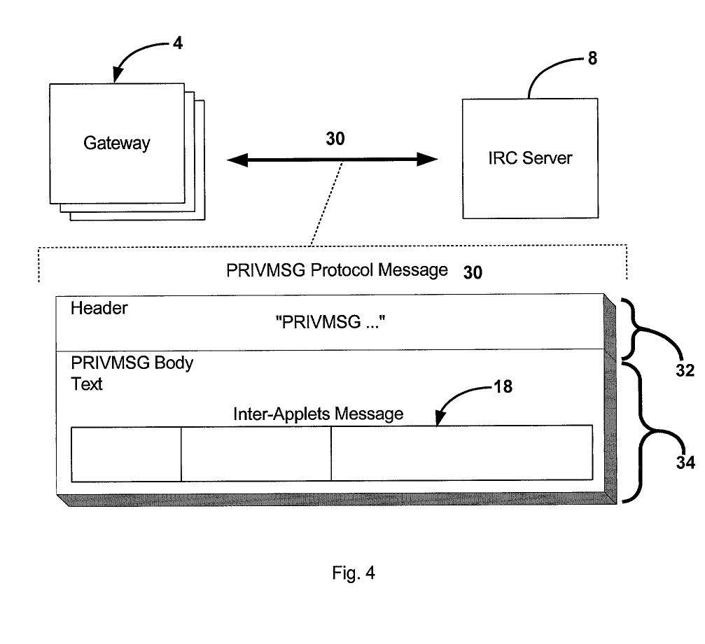

FIG. 4 is a block diagram showing the server protocol message format for the server messages in accordance with the present invention.

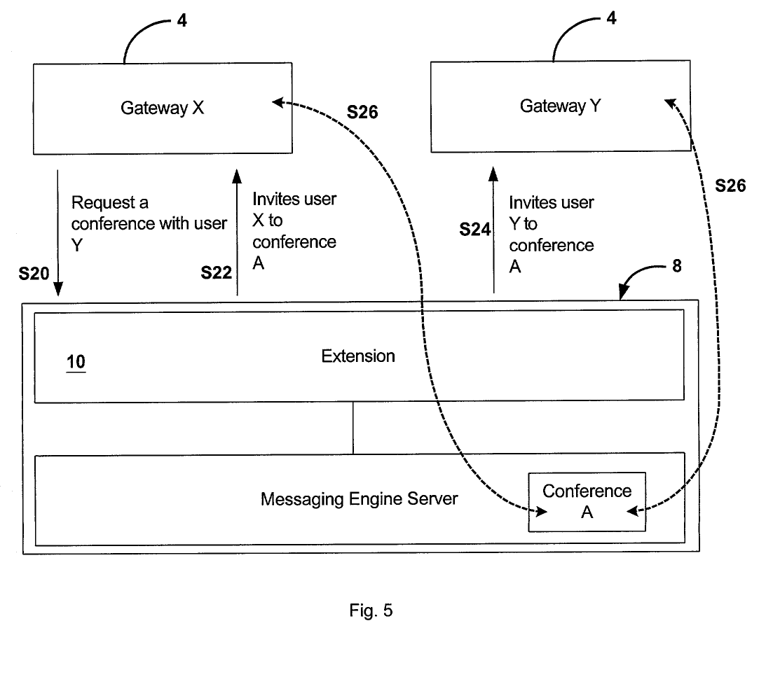

FIG. 5 shows an exemplary diagram of the relational components employed in management of a pre-conference engagement, in accordance with the principles of the present invention.

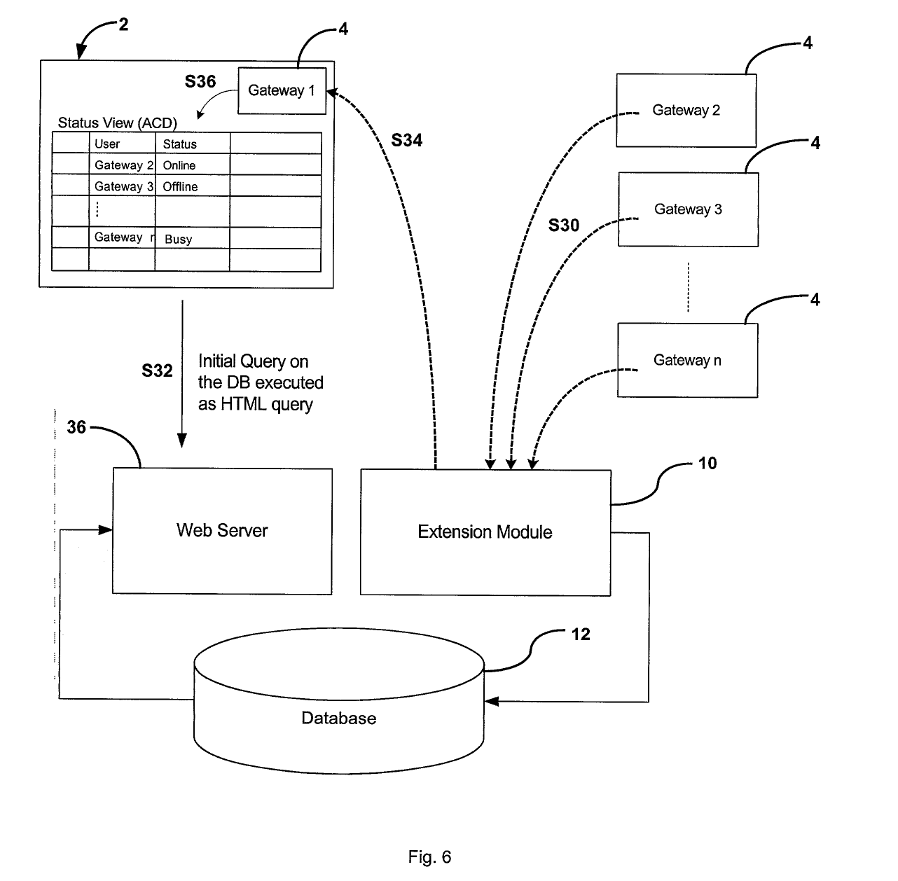

FIG. 6 shows an exemplary embodiment of the relational components employed in management of an electronic directory service, in accordance with the principles of the present invention.

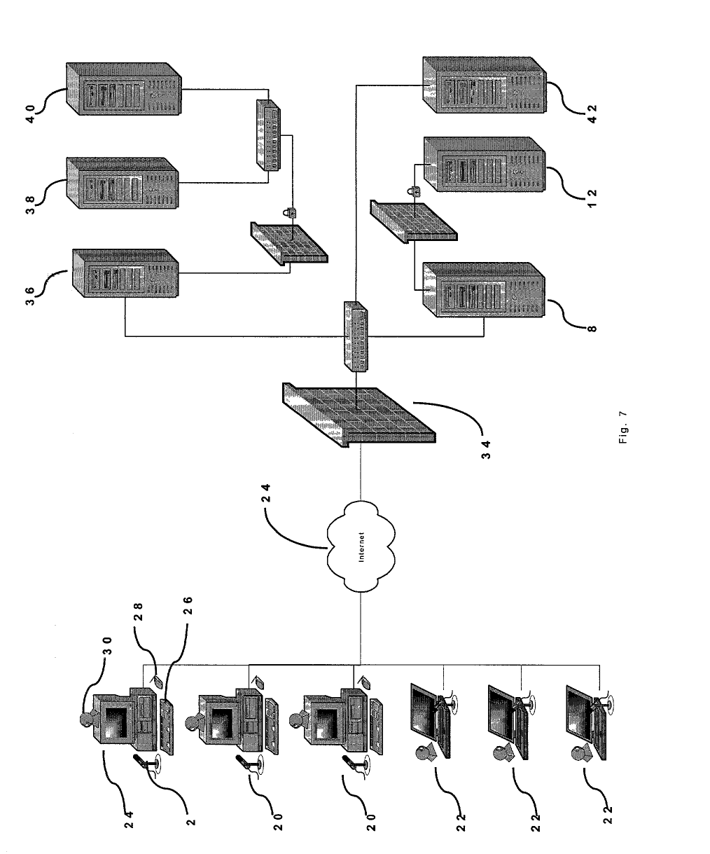

FIG. 7 is an illustration of a system architecture for implementing the computer processing in accordance with a computer implemented embodiment of the present invention.

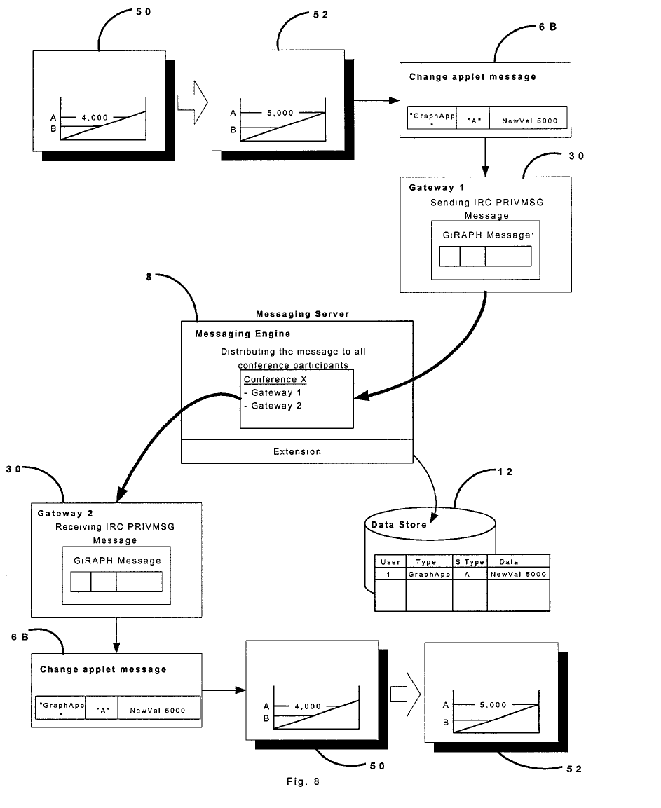

FIG. 8 is a flow diagram showing use of the present invention in local and collaborative mode.

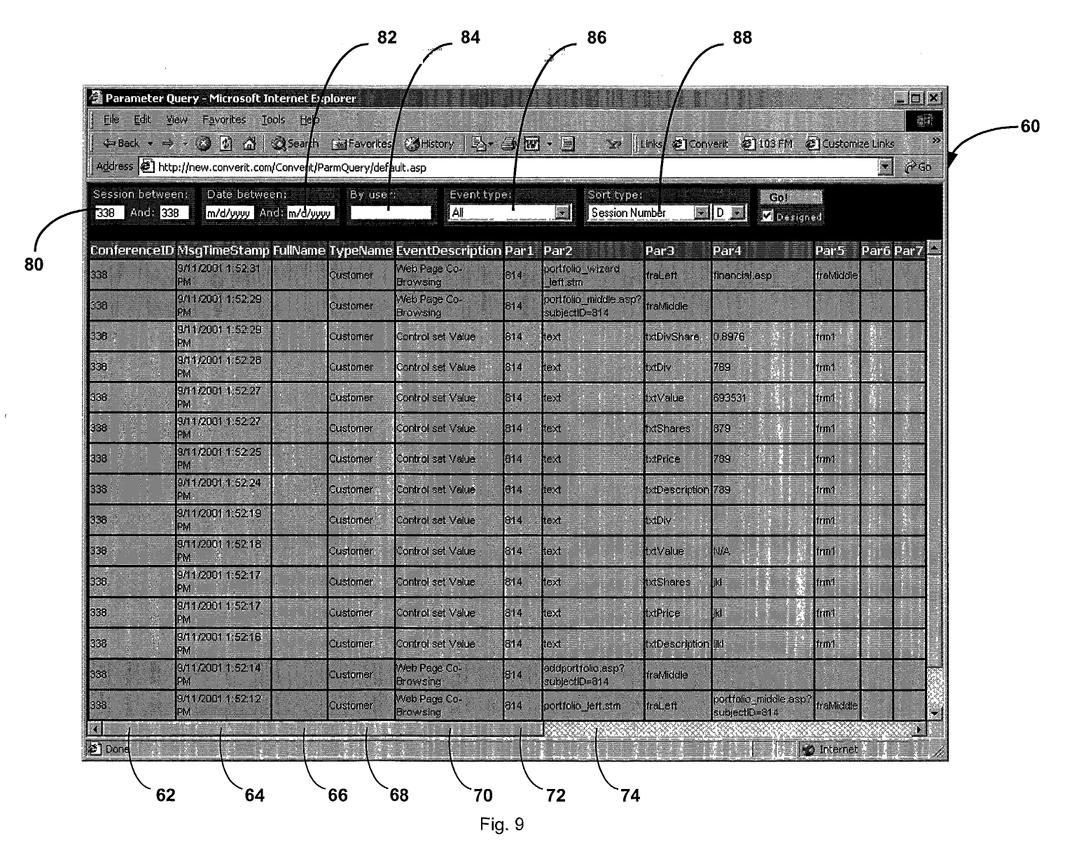

FIG. 9 is a screen shot showing analyzable data captured during an online sales interaction, in accordance with one embodiment of a web page implementation of the present invention.

### SYNTAX/NOTATIONS

The detailed description that follows may be presented in terms of program procedures executable on or technical services provided for a computer or network of computers. These procedural descriptions and representations embody the syntax used by those skilled in the art to most effectively convey the substance of their work to others skilled in the art.

For completeness, it is to be understood that the instant invention is equally applicable to any standard network of computers, of which the Internet is an example. Such networks of computers, for example, include a standard communications protocol such as Transmission Control Protocol/Internet Protocol (TCP/IP), Open Systems Interconnection (OSI) protocol, User Datagram Protocol (UDP), Wireless Application Protocol (WAP), and/or Bluetooth wireless communications protocol or any other network-type protocol, local and/or global.

A procedure here, and generally, is conceived to be a self-consistent sequence of steps leading to a desired result. These steps are those requiring physical manipulations of physical quantities. Usually, though not necessarily, these quantities take the form of electrical or magnetic signals capable of being stored, transferred, transmitted, combined, compared and otherwise manipulated. It proves convenient at times, principally for reasons of common usage, to refer to these signals as bits, bytes, values, elements, symbols, characters, terms, numbers or the like. It should be noted, however, that all of these and similar terms are to be associated with the appropriate physical quantities and are merely convenient labels to these quantities.

Further, the manipulations performed may be referred to in terms, such as adding or comparing, that are commonly associated with mental operations performed by a human operator. No such capability of a human operator is necessary, or desirable in most instances, in any of the operations described herein that form part of the present invention; the operations are machine operations. Useful machines for performing the one or more operations of the present invention include general digital computers or similar devices.

The present invention also relates to a system for performing these operations. This system may be specially constructed for the required purpose or it may comprise a general purpose computer as selectively activated or reconfigured by a computer program stored in a computer. Similarly, the system may be specially arranged to achieve the desired purpose.

The procedures presented herein are not necessarily inherently related to a particular computer or other device. Various general-purpose machines may be used with programs written in accordance with the teachings herein, or it may prove more convenient to construct or arrange more specialized apparatus to perform the required method steps. The required structure for a variety of these machines will appear from the description given.

### DETAILED DESCRIPTION OF PREFERRED EMBODIMENTS

In accordance with a preferred embodiment, the present invention relates to a system and method for capturing, manipulating and analyzing data within one or more applications residing in a web browser. Data herein refers generally to all user events information created, initiated, modified or otherwise affected by one or more users.

The present invention facilitates in part capture of user interactions with information contained in a browser for later playback and manipulation as desired. It can be deployed both in local/stand-alone and collaborative mode.

For example, in the local mode a user is able to record any interactions initiated on a web site, save the interaction locally, and play it back at any time and in any desired fashion (i.e. navigation only, navigation without change applet events, etc.). In a collaborative mode, the user can collaborate in real time with one or more users on the same site simultaneously, by sending the user's interaction events to other users who are connected to the system.

A key feature of the present invention is its flexibility in implementation and operation; it allows users to not only capture their interactions on an intranet, extranet or internet browser, but also to be able to manipulate the data without requiring a high degree of computer knowledge. What is more, the flexibility of the present invention allows users to analyze the captured data to the desired degree of specificity, and share that analysis with others instantaneously, if desired.

Referring to FIG. 1, there is shown a preferred embodiment of the system of the present invention. The system components comprise client modules, consisting of applets and scripts, and optional server modules 8, which include one or more servers and databases, and an extension module 10.

More specifically, one aspect of the client modules constitutes programmed code in the form of a JAVA™ applet 4 that serves as a gateway for recording as data user interactions in a web browser 2. The gateway applet 4 is configured for managing and analyzing the data representing changes in user interactions. It acts as an interface between the functions it performs, via additional applets, such as capture and playback applets, and the server components. The gateway 4 can also communicate directly with the database 12 via XML over HTTP protocols. It divides the capture and playback functionality from a physical communication layer used for collaboration purposes, for example, with other connected users.

In the embodiment depicted, the gateway applet 4 is configured, via additional applets, to perform four functions that can be generally categorized as capture and playback functionalities or applets 6. In a preferred embodiment, the capture and playback applets 6 take the form of separate, programmable functional modules operationally coupled to the gateway applet 4. In an alternative or optional embodiment, the capture and playback applets 6 may be integral of the gateway applet 4.

In the embodiment shown, the capture and playback applets 6 are subdivided into four categories represented by various functions. It is worth noting that the gateway applet 4 can be modified to perform additional capture and playback and/or other features as desired.

The first category of capture and playback applets 6 may be termed a browse applet 6a. The browse applet 6a is a JAVA™ applet component that supports a SendURL method and ReceiveURL event. As such, browse applet 6a captures URL navigations and/or changes, and invokes those navigations and/or changes on request. Because browse applet 6a does not have a user interface, it works in the background, out of view from the user.

During operation as when a user accesses a HTML page having a gateway applet 4 already embedded therein, a script contained in an application (i.e. graphics depicting a bar graph) in the HTML page will initiate communication with the browse applet 6a. The script, which is in constant communication with the browse applet 6a, detects changes made in the page.

Whenever a change or alteration is made, the script calls the SendURL of the browse applet 6a to capture the change event. The browse applet 6a passes the change event, via a change event message, to the gateway applet 4.

After processing, the change event message becomes a ReceiveURL event. The gateway applet 4 actually enforces the change within the browser. Hence, the gateway applet 4 passes the ReceiveURL event to the browse applet 6a, which changes the current URL to the one received and invokes the onReceive or ReceiveURL event for viewer display. The browse applet 6a uses a message format consistent with the server 8 to send and receive URL messages.

The second category of capture and playback applets 6 is called a change applet 6b. The change applet 6b is a JAVA™ applet component that supports a ReportChange method and onchange event. Like the browse applet 6a and any other JAVA™ applet, the change applet 6b can be added to any existing JAVA™ applet. This applet enables an existing applet to be captured and played back for any event that relates to it.

The third category of capture and playback applet 6 may best be described as a form applet 6c. The form applet 6c is programmed, using a combination of Java™ applets and scripts, to communicate with the form objects within each HTML page. A form object is an element, such as a text box, a comment box or an option, that has input fields or form fields.

The form applet 6c supports a ReportDataChange method such that whenever a value in any form field in the HTML page is changed, that change is recorded. Form applet 6c also supports an onFocus event and will call up the ReportFocus function whenever focus is moved from one form field to another. The difference between the ReoportDataChange and the ReportFocus functions is that the ReportDataChange function monitors and records changes made within a form field, whereas the ReportFocus function monitors and records changes made between form fields. Both of these functions are invoked when the form applet 6c receives a message from the server containing form object information.

Finally, the fourth category is the function applet 6d, which is a Java™ applet designed to allow remote execution of script functions. This applet, which supports the RemoteFuncCall method and the onFuncCall event, basically allows a system operator or programmer to audit and/or manipulate the scripts call functions and parameters.

It also allows the manipulation of hidden functions that run within the HTML. This is accomplished by the function applet's generic interface to the gateway component 4 so that a programmer can send messages with the other gateway script functions. Like other applets, the function applet 6d uses and communicates with the server's messages relating to it.

Having presented a few exemplary functions of the capture and playback applets 6, we now turn to a more detailed discussion of the gateway component 4 of the client module, and its exemplary sub-components and functions.

The collaboration services module 4a of the gateway 4, for example, enables a user to collaborate with other users in real time by sending and receiving messages to/from other users over a TCP/IP network, such as a Local Area Network (LAN) using a server or the Internet. This module 4a could be an Internet Relay Chat (IRC) client and is configured to support the server's protocol.

The collaboration services module 4a also supports a SendMessage method and MessageFromServer event. For instance, a capture and playback applet 6 requiring transmission of a message from one user to another user or other participants in a collaborative session, will call the SendMethod method. When the gateway component 4 receives a message from the server 8, the MessageFromServer event takes place and the message is transmitted to the corresponding capture and playback applet, by comparing the message type (i.e. applet name) to the registered applets.

The local events storage module 4b is responsible for the local storage of data recorded by the system. It is worthy to note that the recording of data by the system is capable of occurring substantially instantaneously, not necessarily requiring an instruction command from a user to record data. In this regard, substantially every message that is received by the gateway 4 within a browser can be stored in memory locally, such as in a local computing device. Alternatively and optionally, storage can be to the remote events storage 4d, later discussed.

When in local mode, the local storage module 4b is employed to store data/messages in a local memory buffer, preferably in a table. From there, the data can be manipulated as desired. For instance, data saved via the local storage module 4b can be downloaded and saved to a hard disc or floppy, saved to a file, transmitted electronically via electronic mail or to a pager device, or the like. Further, the data can be manipulated for playback later on. Data playback may occur in a method similar to conventional recorder devices, such as the Play, Stop, Rewind, Fast forward, Pause, and the like.

The registry services module 4c manages the registry database of all capture and playback applets 6 loaded on a browser. It supports a RegExtApplet and UnRegExtApplet method to register and unregister, respectively, each capture and playback applet 6. In this manner, the registry services module 4c facilitates two-way communication between the gateway component 4 and the capture and playback applet 6.

A fourth exemplary module of the gateway 4 is the remote events storage module 4d. The discussion under the local storage module 4b is applicable to the remote storage module 4d, except that the data is stored in a remote location, such as on a messaging server, and preferably over a TCP/IP network. All data is configured and stored in Extended Markup Language (XML) format using Hyper Text Transport Protocol (HTTP).

Referring now to FIG. 2, there is shown a block diagram of the order of actions when a web page, implementing software containing the gateway 4 and capture and playback applets 6 of the present invention, is loaded on a client browser.

The process begins at step 10 (S10) when the gateway 4 is loaded onto a customer browser and connected to a server, preferably a messaging server. At this juncture, the capture and playback applet 6 is loaded and, via inter-applet messages with the gateway component, becomes registered. Preferably, the browse applet 6a only is initially loaded on the browser, and is registered with the gateway 4.

In a preferred embodiment, all remaining capture and playback applets 6, such as the change applet 6b, the form applet 6c and the function applets 6d, are loaded on demand. The practical reason for this preference is because change and/or navigation capturing is often times a needed functionality from the beginning of a conference, for example, whereas HTML forms capturing is usually required only when an HTML form exists on a web page.

Once the applet(s) 6 is/are registered, as appropriate, the capture and playback applet communicates with the gateway 4 by sending and receiving inter-applet messages via two-way communication (S12). This ensures that all user interactions made on the browser are captured. When use of the applet(s) 6 becomes unnecessary, such as when a HTML page is unloaded, the applet 6 unloads itself and in the process becomes unregistered with the gateway (S14).

Regarding the constituent components of the inter-applet messages 18, these messages are transmitted as string messages between the applets and a browser. Inter-applet messages 18 are used to communicate between the gateway component 4 and the capture and playback applets 6.

For instance, the inter-applet message corresponding to the browse applet 6a that travels between the browse applet 6a and the gateway component 4 is the browse applet message 6A. The inter-applet message corresponding to the change applet 6b that travels between the various applets and the gateway applet 4 is the change applet message 6B. Similarly, the inter-applet message corresponding to the form and function applets that travels between the form and function applets 6c, 6d, respectively, and the gateway component 4 are the form applet message 6C and the function applet message 6D, respectively.

Each inter-applet message 18 is constructed in a standardized format that comprises three parts, as shown in FIG. 3. The first part comprises the message type 20, which is the name of the sending applet. As depicted, an example of a message type is the browse applet 6a.

The second part of an inter-applet message 18 comprises the message sub type 22. The message sub type 22 provides the definition of the sub message type. For example, for the browse applet message 6A, there are two message sub types 22: SURF_TOGETHER, which represents the sending or transmission of a Universal Resource Locator (URL); and READY_STATE, which signifies when browsing has ended.

For the change applet message 6B, the message sub type 22 and data structure are implemented according to the requirements of the application being processed. For instance, if an existing applet called “applet1” has a scrollbar on the interface called “scrollbar1” and it is desirable to capture each change in this scrollbar object, then a new inter-applet message would be constructed. The new message would have a message type called “applet1” and message sub-type called “scrollbar1”. The message data section holds the scrollbar position value. In this manner, the change applet message 6B is able to capture any object as on an existing applet.

For the form applet message 6C, there are two message sub types 22: FOCUS, which signifies when a change in focus occurs; and DATA, which indicates when a data value has changed. A change in the focus means that the cursor moved from one object to another, much like using the tab key.

For the function applet message 6D, the message sub type 22 is the FUNCCALL, which signifies a request made to call a function remotely. Those functions are script functions and enable a programmer to capture and playback function calls, which are not directly activated by a user event like a mouse/keyboard click.

The third and final part of an inter-applet message 18 comprises the message data 24, which is the actual message data that is structured according to the message type. For the browse applet message 6A, the data structure corresponding to the SURF_TOGETHER message sub type refers to the pairing of a window name and a URL name. The READ_STATE data structure is empty.

For the change applet message 6B, as indicated above, the data structure is implemented according to the requirements of the application being processed.

For the form applet message 6C, there are two data structures corresponding to each message sub types 22. For FOCUS, the data structure provides the name of the object to receive the focus. For DATA, the data structure provides pairs of object names and its corresponding data values. For instance, if a user enters a value of “34” in a field named “txtAge” then the data structure would look like “txtAge|34”.

For the function applet message 6D, the data structure represents the name of the function to call in addition to the array of parameters required.

The second type of system messages is the server protocol messages 30. FIG. 4 is a block diagram showing the format of these messages. Server protocol messages 30 travel between the gateway component 4 and the messaging server 8. They comprise inter-applet messages 18 formulated into a PRIVMSG message that is transmitted preferably over a TCP/IP network.

The constituent components of the server protocol message 30 include a header section 32 and a body section 34. The header section 32 describes the message parameters, such as identification of the sender, recipient, etc. The body section 34 is the message text, which comprises the inter-applet message 18 converted into a string buffer. Accordingly, the inter-applet message 18 is sent as the PRIVMSG body text.

Referring back to FIG. 1, we turn to a more detailed discussion of the messaging server 8 containing all the data. Messaging server 8 may comprise one or more computers configured with high speed internal data buses having the capability to sustain a significant level of data traffic. In a preferred embodiment, the invention uses existing internet infrastructure, in addition to a network architecture herein described, to accomplish efficient, reliable and inexpensive delivery of data, including multimedia data, to users.

The messaging server 8 preferably comprises an Internet Relay Chat (IRC) server and an extension module 10 operatively coupled to the server, used to store messages. The messaging server 8 preferably comprises a messaging server and operates in a conventional manner.

Further, the IRC protocol has the built-in capability of managing multiple channels of users and exchanging messages between them. This capability allows the messaging server 8 acts as a relay server in transporting inter-applet messages between users of a same conference. In this instance, each user's gateway 4 connects over a TCP/IP network to the messaging server 8 and identifies itself as “GateX”, where X represents a user's identification number. Once connected, each gateway 4 represents a user with a browser able to participate in IRC channels or conferences with other gateways.

The extension module 10 is preferably a Component Object Model (COM) extension module, and is designed to implement a chat server extensibility application programming interface (API). It enforces the business rules or logic by extending the messaging server's functionality to support the system's specific requirements. Extension module 10 is configured to supervise the messaging server messages (i.e. control messages) to/from each user.

The extension module 10 performs three important functions. First, it administers all the storing and retrieving functions of the messaging server 8 to process storage of data. Data is parsed and maintained as real data enabling further data analysis.

Second, the extension module 10 administers all the functions necessary for conference management. These functions include operational functions, such as those pertaining to setting up a conference start time, end time, session manager, etc., as well as configuration of system functions, such as those pertaining to user log-in access, viewing functionality and the like.

FIG. 5 shows an exemplary diagram of the relational components, including the extension module 10, employed in management of a pre-conference engagement. In a preferred embodiment, management of the pre-conference engagement begins when a first user Y, having a gateway X, sends a control message to the extension module 10 requesting a conference with a second user Y, having a gateway Y, as at S20. Upon receipt of the request, the extension module 10 invites user X, as at S22 and user Y, as at S24, or additional users, to the conference A.

Each user receiving the invitation, in this instance users X and Y, has an opportunity to accept or decline the conference invite. If users X and Y accept, communications flow between the users X and Y, via gateways X and Y, respectively, to conference A, as at S26.

More specifically, each user X and Y indicates acceptance of the conference invitation by sending an appropriate message to the messaging engine server 8, which in turn issues an IRC JOIN message to users X and Y to join conference A.

The third function the extension module 10 performs is management of an electronic directory service. It administers an online/offline directory of available users, useful for collaboration, such as when one user seeks online collaboration with one or more users.

FIG. 6 is an exemplary embodiment of the relational components that accomplishes this function. In a preferred embodiment, management of the directory begins when each user, represented by gateways 1, 2, etc., connects to the messaging server 8, as at S30, where each user is written to the database 12 as an online user via extension module 10.

Generally, the gateway maintains conference status information on each user. For instance, when a user is connected in a conferencing session, the user is designated as ‘busy’. Upon disconnection from the session, the user is designated as ‘offline’. An ‘online’ status indicates a user is available online.

After connection to the messaging server 8, a user seeking to locate another user for a conference, employs a web browser to send a query to the database 12 for all available online users. This search is accomplished through a web server 36, which communicates with the database 12. The database 12 is updated with the current user status information constantly by the extension module 10.

When a change in user status occurs, a control message from the extension module 10 is transmitted to the querying user, as at S34. Because all change status updates are performed in real time using dynamic HTML, as at S36, without the need to re-execute the query, a user is able to view change status information substantially instantaneously.

The extension module 10 allows a programmer or system operator to initiate or modify specific rules, and in turn initiate or modify functionalities, as desired. For example, one such feature may be to trigger an alarm condition to a session manager if a conference participant moves a scroll bar above or below a desired threshold value, such as 90 percent.

Alternatively, the feature may be set to trigger an alarm to a supervisor not participating in the session, notifying the supervisor that it is necessary to join the session. Any number of desired scenarios is possible. The extension module 10, which has access to every message, monitors and manages the messages for action as programmed. Further, alternatively and optionally, the extension module 10 is also programmable for functionality changes to be made by a user.

FIG. 7 is an illustration of a system architecture for implementing the computer processing in accordance with a computer implemented embodiment of the present invention. It shows a plurality of workstations 20, 22 connected to a global network, such as the internet 24, via an Internet Service Provider (not shown), in accordance with one embodiment. Advantageously, the instant invention is equally applicable to any standard network of computers operative with standard communications protocol. Alternatively and optionally, the system architecture accommodates internet access to electronic data files through other home electronic equipment, such as a television, stereo, cable, modem and the like.

The workstations 20 each include a central processing unit having one or more disc drives, which may include a floppy disc drive, a hard disc drive, CD ROM or digital video disks (DVDs). Different computer configurations may have varying disc drives that fall within the scope of the system capable of implementing the present invention.

The computer workstation 20 also includes a display 24 where information is displayed to the user, and user interface devices. These devices may include a keyboard 26, joystick or a mouse 28, and provided as input devices to interface with the workstation's central processing unit.

Other input devices adaptable to the workstation 20 include a touch pad control device, a track ball device, and infrared (IR) transmitter/receiver for transmitting/receiving IR signals, and the like. A web cam 30, microphone or speaker 32 may also be used with the workstation 20. The speaker 32 receives voice signals acquired through digital-to-analog conversion by an audio controller that outputs the signals as voice. Through the audio controller and microphone, the computer is capable of receiving and processing voice information.

In accordance with the principles of the present invention, the central processing system may also include a laptop or notebook 22. The above-mentioned input devices also apply to the laptop 22. In addition, the central processing system can be replaced by or combined with any suitable processing system operative with the present invention, including hand-held computing devices, palm pilots, pagers, palm top computers, notebook PCs, desk-top personal computers, mainframe and super computers, gaming devices and the like.

As a security measure, a firewall 34 is preferably employed between the internet 24 and the one or more servers that provides processing support. In the embodiment depicted in FIG. 5, the hosting web site employs a web server 36, application server 38 and an SQL database server 40. A back-end architecture of the present invention includes a messaging server 8, a database server 12 and optionally a collaboration server 42. The collaboration server 42 allows the back-end architecture to support collaboration of audio and/or video data between two or more remote users.

All of the above components operate synergistically as a powerful technology tool for users seeking to capture their interactions, with any application residing in a browser, record their interactions as data points, and retrieve the data for later manipulation as desired. For example, it allows a user preparing a web presentation to record all actions and later playback the recorded session in any desirable manner.

Advantageously, the present invention is also useful as a collaboration tool, such as when two or more users are connected to a web site containing the gateway and capture and playback applets of the present invention. An exemplary embodiment showing operation of the present invention in both scenarios, is shown in the flow chart depicted in FIG. 8.

The process begins when a user connects to a web site via a web browser, and accesses a web server 36 through a messaging server 8. Preferably, the messaging server 8 assigns a user access identification number and sets up the collaboration session. If the session also requires a voice and/or video channel, then a new collaboration session is also opened on the collaboration server 42. Then, the gateway component 4 and capture and playback applet 6 are loaded. That is, the HTML instructions in a home page of the web site is modified or embedded with at least the gateway 4 and browse applet 6a for detecting the structure of the HTML as well as for detecting any changes to the HTML.

In this instance, a software application containing the graph 50 in FIG. 8 is monitored by the capture and playback applets 6, which communicates all changes with the gateway 4. The graph's default user interface is line A having a value of 4,000. Graph 52 reflects the change of line A from 4,000 to 5,000. This change is accomplished when the graph applet implements the change applet 6b, which in turn communicates it to the gateway 4, which in turn creates an inter-applet message called the change applet message 6B that reflects the change on the user's display.

Through the messaging server 8, the change applet message 6B in further transmitted to the gateway component 4, which is already loaded on the web page. Upon receipt of the change applet message 6B, the gateway 4 formulates it as an IRC PRIVMSG protocol message 30 and transmits message 30 to the messaging server 8.

These actions occur when the gateway component 4 is in the collaborative mode only. If a collaboration session is not desired, use of the collaboration server 42 and the messaging server 8 is omitted, and the change applet message 6B is retained internally within the gateway 4 for later manipulation by a user.

Preferably, the messaging server 8 stores all received messages in the data store 12. Since the gateway 4 is in the collaborative mode, all changes made to graph 50 by a first user will be posted to the other users connected in the collaborative session.

Posting of data to the other users, occur in substantially reverse order as previously described. For instance, at this juncture a gateway component 4 is already installed at a second user's web page. The gateway 4 at a second user location receives the PRIVMSG server message 30 from the messaging server 8. Upon receipt, the gateway 4 will unwrap from the server message 30, the change applet message 6B and send the message 6B as an inter-applet message to the change applet 6a on the same page. The change applet 6a, upon receipt of the change applet message 6B, will extract the message parameters and apply them to the graph 50 to produce the change in graph 52. If other users were connected in the collaborative mode, operation would be performed as described above. The collaborative mode description herein is applicable to FIG. 1 also.

Regarding data store 12, this storage device is divided into two areas. A first area stores the inter-applet messages. It is used when the system operates in the local or collaborative mode. In the local mode, the data store 12 takes the form of local memory storage on the gateway component itself. The data store 12 can be saved on local files on a user's computing device.

In the collaborative mode, the data store 12 takes the form of a SQL database operatively connected to a server. In this configuration, the data store 12 receives, parse and saves each inter-applet message. This enables later manipulation, such as playback, of conferences or collaborative sessions, and further analysis of the conference content.

The second area of the data store 12 stores the conference management data. For example, the second area may store information concerning the: conference start time, which is generally an exact server time the conference starts; the conference length, which refers to the exact length in seconds of the conference; and/or the conference owner, which refers to the user who will initiate the conference.

The second area is also capable of storing conference subject identification, which is a description of the conference. For instance, if a user initiated a conference about a specific product, the product's identification number may be used as the conference identification number that users view. A conference ID may comprise one or more identification identifiers.

Finally, the second area may store information on the conference participants. The second area becomes relevant only in a collaborative mode.

It should be recognized that the system and methods for carrying out the present invention, as described herein, are not limited by the functionality described, by the number of participants, by the medium over which they communicate, or by the input or display devices used. The systems and methods of the present invention are applicable to all existing interactive electronic medium and devices including, but not limited to, the internet, intranet, personal computers, interactive television, WAP telephones, pagers, wireless devices, and other interactive electronic medium and devices to be developed.

It should be also recognized that the user of the present invention and method can be any entity seeking to capture user interactions with information contained in a browser. Because of the system's way of treating and manipulating electronic data, the entity is capable of providing a high level of specificity through the gateway component with regard to how much and in what way is the captured information to be configured for later playback.

For example, when implemented on a web site, the present invention extends the capability of a web site to allow auditing of any activity on the site in real time. Noteworthy is the point that all activity, including web page activity performed by a user as well as web page/site activity not activated by a user, is monitorable in accordance with the principles of the present invention.

Further, when implemented on a web site having chat/audio/video functionality, the present invention provides a complete collaborative platform that allows any number of participants to collaborate on web pages.

An example is useful. Referring now to FIG. 9, there is shown one embodiment of a web page showing implementation of the present invention on a web site. More specifically, FIG. 9 shows a database capture of an entire sales interaction between a user/customer and a financial services company representative over the internet for the purchase of life insurance, for instance.

The database capture is represented by a screen shot 60 that contains a record of every transaction data, which is shown in a tabular format. The first five columns refers to conference parameters, and the remaining eleven columns contains data.

The first column 62 contains information as to the conference identification number. The message time stamp column 64 shows the date and time that user interaction. The full name column 66 shows the name of the user who initiated the interaction. The type name column 68 provides information as to the type of user that initiated the interaction. Here the two people participating in the sales interaction are the customer/purchaser and the agent selling the product.

The event description column 70 describes the type of applet employed in the sales interaction. A chat applet, retirement planner or a browse applet, as shown in FIG. 9, may be employed. The data columns 72, 74 capture data for each interaction by each participant for each applet types employed.

Above the data table section of screen 60 lies a plurality of search engines 80, 82, 84, 86, 88 that enables searching of the data in a variety of ways. For example, the session engine 80 allows searching of a session by conference ID numbers. Searching can be done by an individual conference ID or via one or more conference groupings as desired.

The date engine 82 allows searching of a session by date, either individually or by date groupings. The user engine 84 allows searching by conference participant. Searching may be achieved by entering a user's conference identification number, or other types of identifiers, as desired. Similarly, the event type engine 86 facilitates searching of the sales interaction data by applet type employed in the sales interaction. Any custom applet, which was captured during a session, may be listed in an event type drop down menu. Also, the sort engine 88 allows for searching of the data by any classification such as by user name, session number, time interval, event description, and/or session date.

Hence, in a collaboration aspect of the present invention, including via a web site, the collaboration can be used to help financial services companies increase sales by connecting potential customers to a company's existing sales force over the internet. Once connected, sales personnel may use the collaboration aspect of the present invention to sell financial and other products online, in effect replicating a face-to-face interaction.

The system of the present invention allows multiple users, on a narrow bandwidth connection, to communicate and collaborate online. Advantageously, multiple users communicate and/or collaborate online in real time with the necessity of downloading software. Moreover, the present invention allows users or customers to collaborate using sophisticated analytical tools and calculators, complete forms independently or together with one or more participants, as well as communicate with each other using text messaging, voice and/or video.

The system of the present invention also has the ability to connect two users only together without the use of a server. In this instance, the gateway of a first user is connected directly to the gateway of a second user, and collaboration is achieved.

What is more, by capturing the entire electronic interaction between a customer and a salesperson or advisor, the present invention provides a record of the interaction that is useful for sales data analysis, regulatory compliance or for providing the customer with a record of the interaction for his/her files.

The description and drawings are only to be construed as examples of the various different types of computer systems that may be used in connection with the computer assisted and/or implemented process of the present invention. The many features and advantages of the invention are apparent from the detailed specification. Thus, it is intended by the appended claims to cover all such features and advantages of the invention that fall within the spirit and scope of the invention.

Further, since many modifications and variations will readily occur to those skilled in the art, it is not desired to limit the present invention to the exact construction and operation illustrated and described. Accordingly, all suitable modifications and equivalents similarly fall within the scope of the invention.

What is claimed is:

1. A system for recording as real data one or more change events in a browser, wherein said real data includes function calls that are directly activated by a user event and function calls not directly activated by a user event, said system comprising:
(a) one or more gateway components each substantially configured for at least one of registering, storing and managing recorded data representing said at least one or more change events, each gateway component managing recording of said data in such a way that the data recorded is capable of data analysis to a desired degree of specificity; and
(b) one or more capture and playback applets, each in operative communication with said one or more gateway components, substantially configured for performing all functionalities necessary to effect recording and manipulation of said at least one or more change events as desired.

2. The system according to claim 1, wherein each gateway component acts as an interface between said one or more capture and playback applets and one or more optional server components.

3. The system according to claim 1, wherein said one or more capture and playback applets is integral with said one or more gateway components.

4. The system according to claim 1, wherein each gateway component is modifiable to perform additional features as desired.

5. The system according to claim 1, wherein each gateway component further comprises a collaboration services module configured to allow collaboration between one or more users in real time.

6. The system according to claim 1, wherein each gateway component further comprises a local storage module configured to allow local storage of at least one of data and a message.

7. The system according to claim 1, wherein recording of data occurs substantially instantaneously without requiring an instruction command from a user.

8. The system according to claim 1, wherein each gateway component further comprises a registration module configured to manage registration of capture and playback applets loaded on a browser.

9. The system according to claim 1, wherein each gateway component further comprises a remote storage module configured to allow remote storage of at least one of data and a message.

10. The system according to claim 1, wherein each capture and playback applet further comprises a browse applet configured to detect one or more change events made to a web page.

11. The system according to claim 1, wherein each capture and playback applet further comprises a change applet configured to enable recording and subsequent manipulation of an existing applet and any change event associated with said existing applet.

12. The system according to claim 1, wherein each capture and playback applet further comprises a form applet configured to communicate with one or more form objects in a HTML page.

13. The system according to claim 1, wherein each capture and playback applet further comprises a function applet configured to allow remote execution of script functions.

14. The system according to claim 1, wherein each capture and playback applet interfaces with each gateway component.

15. The system according to claim 1, and further comprising a messaging server configured to manage multiple channels of users and to exchange messages between them.

16. The system according to claim 1, and further comprising an extension module, operatively connected to a messaging server, configured to supervise said messaging server messages.

17. The system according to claim 16, where said extension module further administers storing and retrieving functions of said messaging server.

18. The system according to claim 16, where said extension module further administers substantially all functions for conference management.

19. The system according to claim 16, where said extension module further administers configuration of system functions to allow modification to user log-in access.

20. The system according to claim 16, where said extension module further manages an electronic directory service of users.

21. The system according to claim 16, where said extension module further performs dynamic updating of user status information to a database.

22. The system according to claim 1, further comprising a storage device for storing at least one of data and a message, in local or collaborative mode.

23. A protocol for applet communication that captures one or more interactions involving web browser content information, said protocol comprising:
(a) code instructions for detecting a change event in a browser;
(b) code instructions for detecting a change event in an application object;
(c) code instructions for detecting a change event in form objects in a HTML page;
(d) code instructions for detecting a change event in one or more script functions in a web page;
(e) code instructions for supporting send/receive and save/load functions of captured data between two or more users who collaborate in real time;
(f) code instructions for local storage of captured data;
(g) code instructions for remote storage of captured data; and
(h) code instructions for management of a registry database of captured applets loaded on a browser.

24. A software useful for managing one or more interactions involving web browser content information, said software comprising:
(a) program procedures for capturing a change event in a browser;
(b) program procedures for capturing a change event in an application object;
(c) program procedures for capturing a change event in form objects in a HTML page; and
(d) program procedures for capturing a change event in one or more script functions in a web page.

25. The software according to claim 24, further comprising program procedures for supporting collaboration in real time between two or more users.

26. The software according to claim 24, further comprising program procedures for locally storing said captured change event.

27. The software according to claim 24, further comprising program procedures for remotely storing said captured change event.

28. The software according to claim 24, further comprising program procedures for managing registry of captured applets loaded in a browser.

29. The software according to claim 24, wherein said change event is represented by data capable of analysis to a desired degree of specificity.
